(19) United States
(12) Patent Application Publication
(10) Pub. No.: US 2014/0338539 A1
(43) Pub. Date: Nov. 20, 2014

(54) Ammonia Gas Removal and Evaporative Air Cooling Apparatus Applicable to Livestock Confined Facilities and Fabrication Thereof

(71) Applicant: Chong Mook Park, Falls Church, VA (US)

(72) Inventor: Chong Mook Park, Falls Church, VA (US)

(21) Appl. No.: 13/895,368

(22) Filed: May 16, 2013

(51) Int. Cl. B01D 53/18; A01K 31/22

(52) U.S. Cl. CPC B01D 53/18; A01K 31/22
USPC 96/324

(57) ABSTRACT

The present invention involves a fabrication of ventilation-fan-ammonia-gas-removal-device and dual-function-ammonia-gas-removal-and-air-cooling-equipment for application to livestock confined facilities. The former is installed on the wall of livestock confined facilities to remove ammonia gas from ventilating air and the latter is installed inside the livestock confined facilities to remove ammonia gas and to cool air, suspending from the ceiling of livestock confined facilities. They are fabricated by assembling several plastic-rod-screen-fills which are made with plastic rods. Water supplied from the top of devices, flowing down on the surface of rods, cools air or absorbs ammonia gas and water vapor by contacting with air traveling transversely to the descent of water on the surface of plastic rods by means of forced draft. The dual-function-ammonia-gas-removal-and-air-cooling-equipment has high ammonia gas removal and air cooling efficiencies and also the ventilation-fan-ammonia-gas-removal-device high ammonia gas removal efficiency. Their fabrication methods are described in the present invention.

### CROSS-REFERENCE TO RELATED APPLICATION

References Cited

U.S. Patent Documents
US 2002/0078704 A1, Jun. 27, 2002, John L., Stich, Mesa, Ariz. (U.S.)
U.S. Ser. No. 13/053,382, Mar. 22, 2011, Park, Va. (U.S.)

Foreign Patent Documents

| | | | |
|---|---|---|---|
| KR | 100393126 | Jul. 18, 2003 | Park |
| KR | 100516391 | Sep. 14, 2005 | Park |
| KR | 100516392 | Sep. 14, 2005 | Park |
| PCT | WO 2005/008159 A1 | Jan. 27, 2005 | Park |

Other Publications
http://www.kimre.com/contact._us/AccuPac.pdf, Kimre: ACC-PAC Mist Eliminators, http://www.process-vooling.com/copyright/bf9b3bbf7a5b7010VgnVCM′00000f932a8c0, Tower Performance, Inc. Film Fills-C.E. Shepherd Company,
Nitrogen in the Environment: Sources, Problems, and Managemnt, By Jerry L. Hatfield, Ronald F. Follett, Amsterdam: Boston; 2^{nd} ed., 2008/Wikipedia.
PSCI and IRDA, 2003, Reduction of Odor and Gas Emissions from Swine Buildings Combining Oil Sprinkling and Dietary Manipulations, Final Report.
The Engineering ToolBox, http://www.Engineering ToolBox.com
Formisano B., Tanidess Water Heater—What You Need to Know, About.com Guide, http://homerepair.about.com/od/plumbingrepair/ss/tankless_hwh_{—}5.htm
Denes Kallo, Wastewater Purification in Hungary Using Natural Zeolites, Natural Zeolites '93, D. W. Miog and F. A. Mumpton, pp 341-350.
http://www.ecochem.com/t2556.html.
Anonis A. Zorpas, et al, Sustainable Treatment Method of a High Concentrated NH₃ Wastewater by using Natural Zeolite in Closed-Loop Fixed Bed System, Open environmental Science, 2009, J. 70-76.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Filed of the Invention

The present invention relates to simultaneous removal of ammonia gas and cooling air in livestock production confined facilities. More precisely, the present invention relates to Ammonia Gas Removal and Evaporative Air Cooling Apparatuses for use inside of the livestock houses and the ventilation fan ammonia removal device to be installed on the wall of the livestock houses, utilizing plastic rod screen media. The plastic rod screen media is fabricated with plastic rods using the unique characteristics of plastic rod: flowing down of water on the surface of the vertical plastic rods by gravity, surface tension of the plastic rod strong enough to hold the water on the surface of plastic rod against the strength of draughts in ventilation fans, and capability of contacting water and air on the surface of the plastic rods with barely resisting air flowing through the plastic rod screen media.

2. Description of the Related Art

The ammonia-gas-removal-and-air-cooling-apparatuses (ARAC) of the present invention is an apparatus simultaneously removing ammonia gas and cooling air in livestock confined facilities, which has three major purposes of its operation: the removal of NH₃ which has two major purposes, one of them is to remove a precursor of greenhouse gas generating from livestock production facilities (i.e. reducing of greenhouse gases) and the other is to remove one of causes harmful for growing of livestock animals (i.e. increasing of livestock productions), and the third major purpose is to cool the livestock confined houses (i.e. preventing of thermal shock death of the livestock animals during hot weather). The NH₃ producing during feeding of the livestock is harmful for growing of the livestock animals (significant to poultry), so that it should be removed to maintain its concentration in the livestock houses below its allowable level. During the summer time, the NH₃ gas is removed along with operation of the tunnel ventilation, but in the winter time, its concentration usually rises higher than its allowable level, because the ventilation system is rarely operated to save the heating bill. High concentration of NH₃ causes slow growing of animals leading to the reduction of the animal production. The tunnel ventilation system currently used for cooling the livestock confined houses does not have an enough cooling function during hot weather so occasionally a thermal shock death of the livestock occur. Eventually, the lost of the animal production increases.

Airborne contaminants generated from livestock production facilities include ammonia (NH₃) and hydrogen sulfide (H₂S), dust, and microorganisms. Among them, the NH₃ and H₂S are more affecting to environment than the other contaminants. Especially, the NH₃ is an indirect source of greenhouse gas. Most of the NH₃ and H₂S generated in the livestock production confined houses, where the animals are mainly growing, are ventilated to surrounding environment without filtering as in open facilities. Such ventilated NH₃ and H₂S gases may add the sources of damage to environment and also residents' complaints due to their sharp, pungent, rotten egg smell. The NH₃ gas is identified as one of the important noxious gases and causes a degradation or damage of water and soil quality, and ecosystem, when deposited over surrounding natural water bodies and land. Deposited NH₃ on the soil is reacted with soil moist to produce NH₄⁺ in the soil and decomposed by the consecutive denitrification processes of organic matter in soil to form nitrous oxide (N₂O), long-lived greenhouse gas, see in “Nitrogen in the Environment.” Therefore, it is understood that the atmospheric NH₃ releasing from the livestock facilities is converted to greenhouse gas N₂O. Hydrogen sulfide (H₂S) is also toxic gas to human health and its extremely low concentration irritates human nose, resulting in that residents living surrounding the livestock facilities complain the production of livestock near to their residents. Therefore, the H₂S should be removed from the ventilated air to reduce the source of the residents' complaints due to the operations of the livestock. Eventually, both of NH₃ and H₂S should be removed from the ventilated air to protect natural environment and to reduce the complaints of the residents around the livestock production houses.

Currently, to reduce the amount of the NH₃ gas ventilated from the livestock houses, several operating practices such as reducing of protein contents in feeding or often uses of new litter at every flock of poultry are applied. Such practices may have disadvantage of increasing the poultry or swine prices. But it is reported that such methods can reduce up to 30 to 45% of ventilated NH₃ gas depending on controlling diet, see more information in “PSCI and IRDA, 2003.” This means that a large amount of NH₃ gas is still ventilated. The modern poultry houses are cooled by tunnel ventilation system assisted with wall cooling pad. This system has a weak cooling function of hot air. To meet the cooling condition of the poultry house, the thickness of the cooling pad should be adjusted. Namely, the hotter outside air is, the thicker cooling pad should be used. In turn, a bigger ventilation fan is required. In other words, the cooling pad thickness and fan size should be automatically changed depending on the changing of the hot weather. But the current cooling pad assisted cooling ventilation is not possible to change the thickness of its wall cooling pad. To eliminate such disadvantages, the more accurate and effective removal of NH₃ than animal feeding diet control method currently in use is required and also the higher efficient air cooling apparatus is required to be installed inside of poultry houses.

The purpose of the present invention is a fabrication of ammonia-gas-removal-and-evaporative-air-cooling-apparatus (ARAC) being free of the disadvantages being exhibited in the cooling pad currently in use and preventing the thermal shock death of the animals as well as removing NH₃ and H₂S gases ventilating to environment from the live stock confined facilities and additional purpose is a fabrication of ventilation-fan-ammonia-gas-removal-apparatus (VFAR) being able to remove the NH₃ and H₂S gases only out of ventilating air. The VFAR can be installed on the walls of the livestock confined facilities to remove NH₃ and H₂S gases out of ventilating air and the ARAC installed inside of the livestock confined facilities to carry out both removal of gases and cooling of air in the facilities at the same time.

### SUMMARY OF THE INVENTION

To remove NH₃ generating from livestock production operation and to cool livestock confined facilities, the ventilation-fan-ammonia-removal-equipment (VFAR) and ammonia-gas-removal-and-evaporative-air-cooling-Apparatus (ARAC) of the present invention are invented and proved to be adequate for their application to the livestock confined facilities, since they have several advantages given as follows.
1. They can be simply fabricated without great efforts (through automatic manufacturing lines).
2. They have a high NH₃ and H₂S removal and water cooling efficiencies.
3. They are not attacked by any water chemicals because they are made of inert materials like polyester, high density polyethylene, and polypropylene (any other materials are possible).
4. Their service lives are more than 25 years.
5. They deploy a large surface area of contacting water and air in a relatively small volume, thereby maximizing ammonia absorption and heat transfer.
6. They are of very solid construction without their damage or loss of shape.
7. They are light weight.
8. Their materials are non-toxic, non-hazardous, and suitable for easy and safe disposal at the end of service life.

The key materials used for the VFAR and ARAC to remove NH₃ and H₂S (later on, NH₃ is used for both meaning of NH₃ and H₂S) and to cool air are water and plastic rods or strings (later on, rod is used for both meaning of plastic spiral corrugated rod, non-spiral corrugated rod, and string). The water is normal ground water and the rods are polyester materials which are hardly stretched. The schematic pictures of the VFAR and ARAC are shown in FIGS. 1 and 2. FIG. 1 shows a complete commercial Apparatus of VFAR equipped with an axial motor fan blower and an air and water contactor (AWC) in one unit as the side view of the WAR is shown in FIG. 3. The VFAR is installed on the walls of the livestock confined facilities for removal of NH₃ out of the air ventilating to the environment. When the currently operating ventilation fans are used, however, only AWCs are attached on the rear side of ventilation fans without significant changing of the existing facilities as shown in FIG. 4. FIG. 2 illustrates a complete commercial apparatus of the ARAC equipped with an axial motor fan blower, a water vapor removal device (WVRD) and the AWC in one unit as shown in FIG. 5. The AWC used in both equipments has two functions of removing NH₃ from air and cooling air. When the AWC is used in the VFAR, its function of removing NH₃ only is employed, while both of dual functions of the AWC, removing NH₃ from air and cooling air, are operated when the AWC is employed in the ARAC. The operation of the axial motor fan blower of the ARAC forces air to travel transversely to the vertical rods through the AWC toward the axial motor fan blower which is located in front of the WVRD. The water pumped into the top of the AWC flows down on the surface of the rods by gravity. While both flows of air and water occur at the same time on and over the surface of the rods, the contact of air and water occurs on the surface of the rods, and the water absorbs the NH₃ gas present in the air and simultaneously cools the air. The WVRD has the same configuration with the AWC except that the WVRD has a thinner thickness and closer intervals between the adjacent rods in the WVRD compared with those of the adjacent rods in the AWC. The function of the WVRD is to remove the water vapor being generated during the cooling process of warm or hot air in the AWC to prevent entering and building up of the water vapor in the internal environment of the livestock confined facilities. The absorption of the water vapor in the WVRD is accomplished by contacting water vapor with cool water flowing down on the rods exactly same way with in the AWC. The water vapor is condensed and absorbed on the surface of the cool water whose temperature is lower than dew point of the water vapor. To successfully accomplish absorbing water vapor in the ARAC, the WVRD is installed between the axial motor fan blower and AWC in the sequential order of axial motor fan blower, WVRD, and AWC as shown in FIG. 5. The cooling air enters the AWC by the axial motor fan blower and then dispaches out of the ARAC through the axial motor fan blower after passing the WVRD.

<Fabrication of VFAR and ARAC>

The VFAR of the present invention is fabricated by combining a commercial tunnel ventilation fan and the AWC of the present invention. Therefore, the cross section of the AWC is designed to fit with that of the commercial tunnel ventilation fan or axial motor fan blower used in the livestock facilities. The exact depth of the AWC and WVRD, however, are designed by counting on the air blowing rate of the axial motor fan blower. The dimension of the VFAR is in the range of 100(W)×100(H)×120(D) to 150(W)×150(H)×160(D) cm (other dimensions are possible) and the dimension of the AWC in the range of 100(W)×100(H)×75(D) to 140(W)×140(H)×100(D) cm (other dimensions are possible). While the VFAR is large as given above, the ARAC of the present invention is rather small because 32 of them are installed in a case of poultry house of 50(W)×500(L) ft (each fan has air flowing rate of 20 m³/min). The dimension of the DFARE is 75(W)×75(H)×105(D) cm, which has air flow rate of 20 to 50 m³/min (634 m³/min/32=20 m³/min/each). The fabrication of the ARAC employing the WVRD of the present invention with a dimension of 75(W)×75(H)×25(D) cm is accomplished by joining 2 of AWC of 75(W)×75(H)×25(D), and axial motor fan blower of 75(W)×75(H)×30(D) as shown in FIGS. 12-1 and 12-2.

<Fabrication of PRSF and PRSFs Pack for AWC and WVRD>

The AWC of the present invention is fabricated by assembling several PRSFs packs shown in FIG. 7 which has functions of contacting air and water and absorbing NH₃ gas on the surfaces of the rods. See the US patent application for the function and manufacturing of the string-screen-plates (SSP) and PRSFs which are recently applied to U.S. patents of application Ser. No. 13/052,153 and Ser. No. 13/888,327, respectively. The PRSF used in the present invention is in a thin rectangular shape plate of rods-screen-fills, 25(W)×50(H) and 25(W)×75(H) cm, other dimensions are possible, with vertical-rods-screens (VRS) between top and bottom frames of the rectangular shape plate, whose thickness is in the range of 0.75 to 1.5 cm, other thicknesses are possible, as shown in FIG. 6. The thickness of the PRSF is determined depending on rod diameter. The VRS is comprised of several rods vertically suspended from the top and bottom frames of the PRSF with separated sufficiently apart from each other as shown in FIG. 6. In case of using rod of 10 mm in diameter, the frame of the PRSF has 7 rods with 3 mm thick circular holes surrounding the rod and its thickness is 10 mm. The rods are separated from each other with interval of 34.46 mm between the centers of the adjacent rods, other intervals are possible. Assembling 25 of PRSFs together, standard PRSFs packs in dimension of 25(W)×50(H)×25(D) and 25(W)×75(H)×25(D)cm are fabricated as shown in FIG. 7 and their top and bottom surfaces are shown in FIGS. 8-1 and 8-2. FIG. 8-2 schematically illustrates more in detail the picture of the top plate enlarging a part of the top view of the PRSFs pack and how to attach the rods on the holes being able to hold the rods at the center of the holes. FIGS. 8-1 and 8-2 show the configuration of the staggered arrangement of holes. The rods are located at the vertexes of equilateral triangle whose side length is 20 mm. Such configuration of the rods maximizes the air cooling effect and removal of NH₃, since air flows in zigzags among the rods to maximize the contact area and time between air and water on the surface of the rods. The fabrication of the PRSF and PRSFs pack are described in detail in U.S. patent application Ser. No. 13/888,327. The PRSFs packs are employed for fabrication of AWC and WVRD.

The PRSFs pack used for the ARAC are in same shape and dimension with those used for the fabrication of VFAR except for the intervals between the adjacent strings. The intervals between the adjacent rods of the PRSF are shorter and so the rods are packed closer than in the VFAR, since the air blowing rate in the ARAC is lower than in the VFAR and a larger specific surface area of the rods is necessary for an effective cooling air and absorbing water vapor. The intervals are reduces to 16.5 mm, 82.5% of those used in the VFAR, and the thickness of hole is reduced to 2.5 mm from 3 mm so that the interval between the centers of the adjacent rod is 33 mm. Then, the specific number, 200, of rods in the PRSFs pack used in the ARAC increases by 1.14 times as many as 157 rods in, the VFAR, resulting in increasing the specific surface area of the rods in the ARAC by the same rate, namely, the specific surface area of ARAC is 1 cm²/cm³, compared with 0.88 cm²/cm³ of VFAR, which are computed using dimension 25(W)×50(H)×25(D) cm of the standard PRSFs pack.

As shown in FIG. 6, the PRSF is in the shape of thin rectangular plate without side frames which consists of top and bottom frame and VRS suspended from between top and bottom frames. The top and bottom frame and VRS are connected in one structure. The top and bottom frames of the PRSF are made to create a complete circular hole with rod at center of hole, when they are assembled. The fabrication of PRSF in one structure of the present invention is accomplished by a plastic injection molding machine. The PRSFs pack fabricated by assembling several PRSFs without side frames shown in FIG. 6 does not have side panels and so to provide side panels on both sides of the PRSFs pack, the PRSFs pack side panel shown in FIG. 9 should be fabricated. The PRSFs pack side panel shown in FIG. 9 consists of top and bottom frames and flat panel of 2 mm in thickness between the top and bottom frames. The PRSFs pack side panel fabricated as shown in FIG. 9 is attached on both sides of the PRSFs pack. To do this with one PRSFs pack side panel, the top and bottom frames of the PRSFs pack side panel are designed to be in same configuration on its both left and right sides. The outsides of the top and bottom frames of the PRSFs pack side panel are flat, but the insides are designed to create holes and cover up holes on the top and bottom perforated plates of the PRSFs pack when the PRSFs pack side panels are attached on the side end of the PRSFs pack as shown in FIGS. 8-1 and 8-2. Hence, the PRSFs pack side panel attached on the one side of the PRSFs pack can be attached on the other side of the PRSFs pack by turning around the panel by 180 degree. The design and fabrication of the PRSF in one structure are described in detail in U.S. patent application Ser. No. 13/888,327.

<Fabrication of VFAR and ARAC>

The AWCs are installed in the VFAR as shown in FIGS. 10-1 and 10-2 which illustrate respectively side view and cross sections, 100(W)×100(H) cm, of the AWC installed in the VFAR. And also the FIGS. 10-1 and 10-2 show that the AWC of VFAR consists of 3 layers of PRSFs packs of 25(W)×50(H)×25(D) with 8 PRSFs packs in a layer. FIGS. 11-1 and 11-2 show the installation of AWC in a large VFAR. The AWC of the large WAR has a cross section of 150(W)×150(H) cm and consists of 4 layers of PRSFs packs of 25(W)×75(H)cm×25(D) with 12 PRSFs packs in a layer. Hence, the depths of the AWCs installed in the WAR are 75 and 100 cm, which consist of 3 and 4 layers of the PRSFs pack in the depth of the AWC, respectively, so that a small WAR requires 24 PRSFs packs of 25(W)×50(H)×25(D) cm and a large VFAR needs 48 PRSFs packs of 25(W)×75(H)×25(D) cm. Attaching of the AWCs of 100(W)×100(H)×75(D) cm and 150(W)×150(H)×100(D) cm on the rear sides of the ventilation fans of 100(W)×100(H)×45(D) cm and 150(W)×150(H)×60(D) cm, respectively, the VFARs of the present invention are accomplished.

The FIG. 12-2 schematically illustrates the rectangular cross section, 100(W)×75(H) cm, of the AWC and WVRD installed in the ARAC and FIG. 12-1 the side view of the DFAARE showing the combination of AWC and WVRD in the ARAC. In the ARAC, the AWC is located at the entrance of air and the WVRD located in the middle zone between the AWC and axial motor fan blower as shown in FIG. 12-1. Such arrangement of the WVRD is necessary because the WVRD has a function of removal of water vapor in air generated in the AWC. The AWC comprises of 3 layers of 4 PRSFs packs of 25(W)×75(H)×25(D) in a layer on the cross section of the ARAC along the depth of the ARAC, so that 8 PRSFs packs are required in the AWC of the ARAC. The WVRD consists of a single layer of 4 PRSFs packs along the depth of the ARAC. The fabrication of the ARAC is accomplished by attaching the WVRD on the back of the axial motor fan blower and then the AWC on the rear side of the WVRD as shown in FIGS. 5 and 12-1.

<Installation of VFAR and ARAC in Poultry House>

The VFARs of the present invention are installed on the wall of the livestock confined facilities as shown in FIG. 13, which illustrates the side wall of the poultry house installed with 5 of VFARs connected to the wet ammonia stabilization system (WASS) circulating water through each of the VFARs and converting wet NH₃ collected in the WASS to fertilizer. In case of constructing new poultry facilities or replacing the old ventilation fans with new ones, the VFARs are employed, but in the case of utilizing the current operating fans as they are, the ammonia gas absorbing devices, AWCs, are attached on the rear side of the currently operating ventilation fans without any changing of the existing facilities as shown in FIG. 4. The installation of the ARACs in the livestock houses and their connection to the WASS are schematically illustrated in FIG. 14. As shown in FIG. 14, the ARACs are suspended from the ceiling of the house and able to slide to the wall of the house to easily do maintenance of the house as well as to simply load and unload chickens. In the house of 50(W)×500(L) ft, 32 of the ARACs are installed in two zigzag lines along the length of the house as shown in FIG. 15 and the direction of blowing air along the line is opposite to that of the other line. Such an arrangement of the ARACs helps the blowing air to uniformly spread and circulate in the house. The water inlet and outlet hoses of the ARACs are respectively connected to main fresh water supplying and spent water collecting pipe lines of the circulating water. The main fresh water supplying pipe line is connected to the outlet pipe of the WASS and the main spent water collecting pipe line connected to the inlet of an underground water cooling tank. The circulation of water is shown in FIG. 14. The main water pipes are in the house to prevent freezing of water in winter and the underground water cooling tank is located at the underground outside of the house. The WASS connected to the ARACs is same with the one used for the VFAR.

### BRIEF DESCRIPTION OF THE DRAWINGS

FIG. 1 is a schematic picture of VFAR (Ventilation-Fan-Ammonia-Removal-Equipment) installed on the wall of livestock confined facilities.

FIG. 2 is a schematic picture of ARAC (Dual-Function-Ammonia-Gas-Removal-and-Air-Cooling-Equipment).

FIG. 3 is a side view of configuration of ventilation fan and AWC (Air/Water Contactor) in VFAR.

FIG. 4 illustrates a schematic picture of ammonia-gas-adsorption-device (AWC) attachable on the rear side of the operating ventilation fan.

FIG. 5 is a side view of configuration of axial motor fan, WVRD (water vapor removal device) and AWC in ARAC.

FIG. 6 is a schematic picture of PRSF (Plastic-Rod-Screen-Fill).

FIG. 7 illustrates a schematic picture of standard basic unit of PRSFs pack assembled a plurality of PRSFs for use in fabrication of AWC and WVRD.

FIG. 8-1 schematically illustrates the top and bottom perforated plates of the PRSFs pack shown in FIG. 7, which is fabricated by assembling several PRSFs shown in FIG. 6 and covered on both sides with PRSFs pack side panels shown in FIG. 9.

FIG. 8-2 shows a schematic picture of enlarged part of top and bottom view of PRSFs pack shown in FIG. 7 and shows how the PRSFs pack side panel is jointed on the side of the PRSFs pack uncovered with a panel.

FIG. 9 illustrates the picture of the PRSFs pack side panel.

FIG. 10-1 is a schematic picture of the side view of the configuration of PRSFs packs and ventilation fan in the VFAR.

FIG. 10-2 is a schematic picture of the cross section of the configuration of PRSFs packs in the VFAR.

FIG. 11-1 is a schematic picture of the side view of the configuration of the large PRSFs pack and large ventilation fan in the VFAR.

FIG. 11-2 is a schematic picture of the cross section of the configuration of the large PRSFs packs in the VFAR.

FIG. 12-1 schematically shows the side view of the configuration of PRSFs packs, WVRD, and axial motor fan blower in the ARAC.

FIG. 12-2 schematically shows the cross section view of the configuration of PRSFs packs in the ARAC.

FIG. 13 schematically illustrates the Ammonia-Gas-Removal-System including VFARs installed on the wall of the poultry house.

FIG. 14 schematically illustrates the installation of ARACs in poultry house and their schematic operating picture.

FIG. 15 shows the arrangement of ARACs installed in the poultry house and air flow directions during their operation.

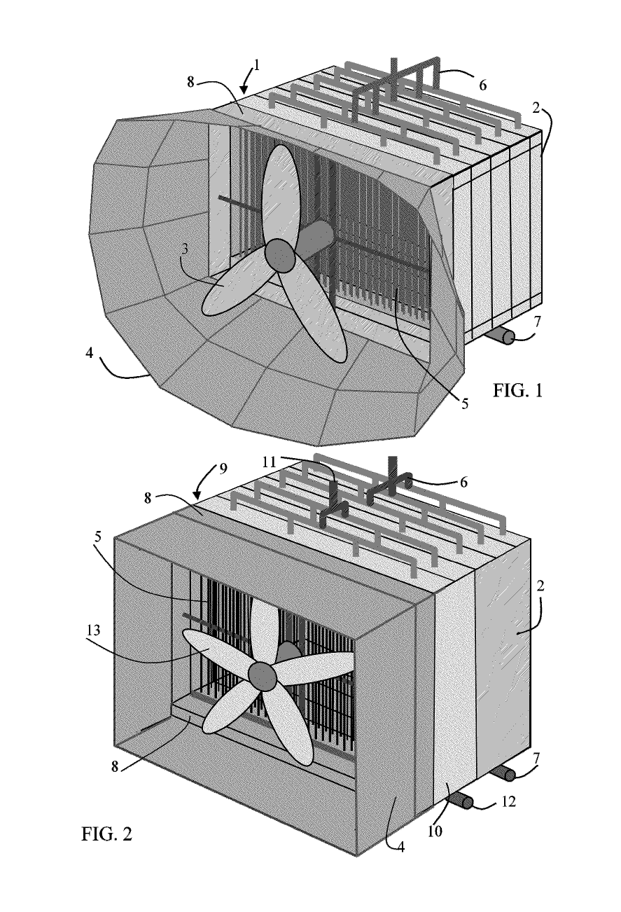

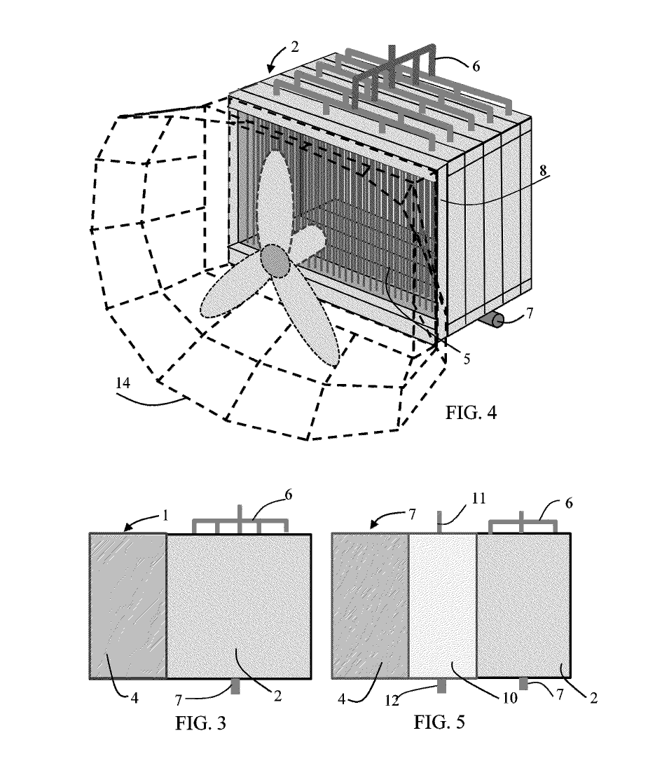

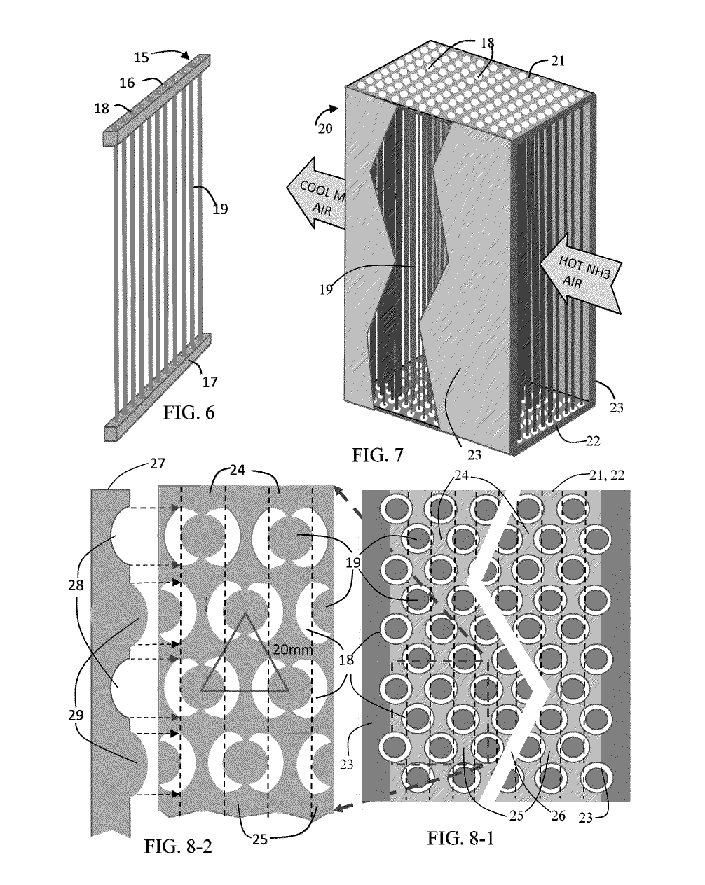

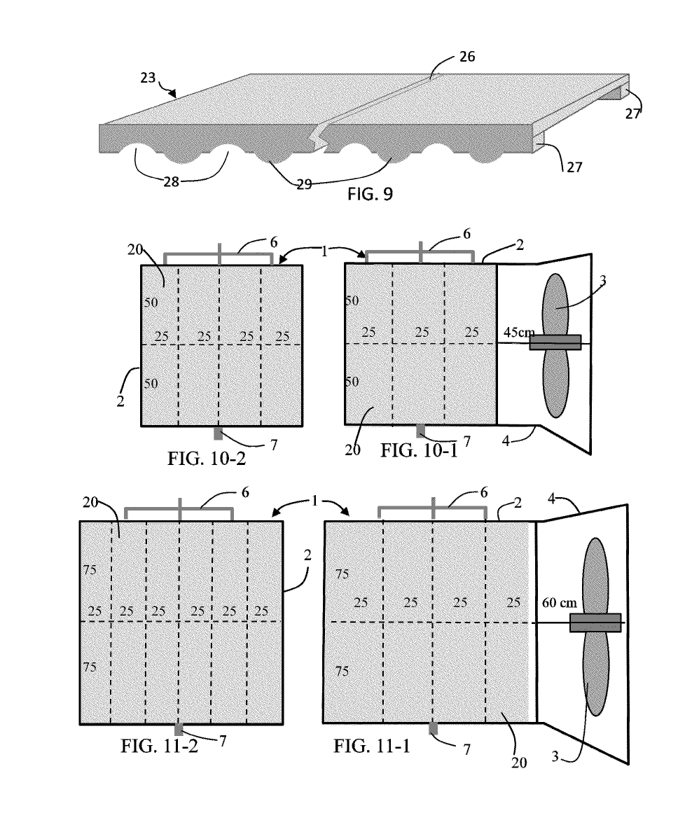

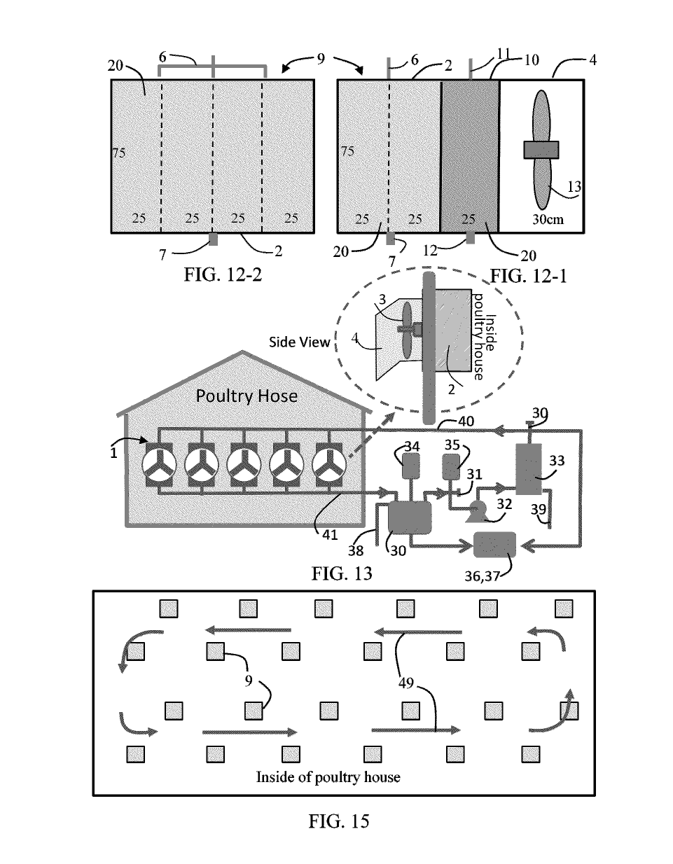

### DESCRIPTION OF NUMBER IN THE DRAWINGS

1 VFAR, 2 AWC, 3 ventilation fan, 4 fan cover, 5 rod screen, 6 inlet port of fresh water, 7 outlet port of water absorbed ammonia, 8 fan attachment frame, 9 ARAC, 10 WVRD, 11 inlet port of cold water, 12 outlet port of water vapor absorbed water, 13 axial motor fan blower, 14 image of currently operating ventilation fan, 15 schematic picture of PRSF, 16 top frame of PRSF, 17 bottom frame of PRSF, 18 hole with rod at its center passing water through it, 19 spiral corrugated rod, 20 PRSFs pack used for absorbing ammonia and cooling air, 21 top perforated plate distributing water into the PRSFs pack, 22 bottom perforated plate passing water out of the PRSFs pack, 23 PRSs pack side panel, 24 PRSF with male attachments, 25 PRSF with female attachment, 26 size reduction gab, 27 upper frame and lower frame of PRSFs pack side panel, 28 hollow for preserving hole, 29 hump for covering up hole, 30 water tank, 31 three way valve, 32 water circulation pump, 33 clinoptilolite ion exchanger column, 34 H₃PO₄ tank, 35 regenerating solution tank, 36 regenerated solution tank, 37 precipitating tank, 38 make-up water supply line, 39 flushing water supply line, 40 water supply line, 41 spent water collecting line (NH₃ absorbed water line), 42 primary filter tank, 43 underground water cooling tank, 44 c/o valve, 45 secondary filter tank, 46 three way valve, 47 to fertilizer precipitation tank, 48 regenerating solution pump, 49 air flowing direction.

### DETAILED DESCRIPTION OF THE PREFERRED EMBODIMENT

There are several factors for designing of the PRSF 15 and PRSFs pack 20 to be determined by conducting experiments and using out sources. However, since the physical characteristics for designing of the PRSF 15 and PRSFs pack 20 are similar with those of the SSP and SSPs pack, the design factors used for designing and fabrication of the SSP and SSPs pack are applied to designing and fabrication of the PRSF 15 and PRSFs pack 20 without any significant modification. Preparation of the design factors of SSP and SSPs pack are extensively described in U.S. patent application Ser. No. 13/053,382 recently applied by the inventor of the present invention. The factors for designing the PRSF 15 and PRSFs pack 20 are the number of rods 19 per unit cross section of the PRSFs pack 20, diameter of holes 18 on the perforated plate 21, 22 of the PRSFs pack 20, diameter of the rods 19, effective length of the rods 19 for effectively absorbing NH₃ and cooling water, verification of flying away of water out of rod 19 due to the air blowing rate of fan, absorbing water vapor by cold water, and absorbing NH₃ into water. The function of the PRSFs pack 20 to contact water with air on the surface of the rods 19 is briefly described here. The water is sprayed on the top perforated plate 21 of the PRSFs pack 20 which has uniformly distributed holes 18 on it and passing through the holes 19, and then flowing down on the surface of the rods 19 suspending between the top and bottom perforated plates 22 of the PRSFs pack 20. While the water is flowing down on the surface of rods 19, the water is absorbing NH₃ gas or water vapor or cooling warm or hot air by contacting with the air entering the PRSFs pack 20 from its one side and passing through the PRSFs 355 pack 20 towards the opposite side. Such functions of the PRSFs pack 20 are verified in the present invention as described below.

<Absorption Mechanism of NH₃ into Water>

The NH₃ gas has high solubility in water, which is 400 to 800 g gas per kg water at the temperature of water 30 to 50° C., respectively, and is fast absorbed on the surface of water, see the solubility of NH₃ in “The Engineering ToolBox, http://www.Engineering ToolBox.com.” Hence, a large amount of the NH₃ gas can be absorbed into water at room temperature and the NH₃ gas is rapidly dissolved into water when it is contacted with water, Therefore, the wider surface for the water to be contacted with NH₃ gas is, the more amount of NH₃ gas is absorbed. To meet such an absorption criteria of NH₃ over the water, to continuously dissolve the NH₃ into the water, and to remove the NH₃ from the NH₃ contaminated air stream, the NH₃ contaminated air should perpendicularly pass through as many vertical rods 19 as possible, on the surface of which the water flows down by gravity. While passing transversely through the vertical rods 19, the NH₃ contaminated air contacts with the water flowing down on the surface of the rods 19. Then, the water absorbs the NH₃ gas from the air stream before discharging out of the AWC 2.

<Cooling Mechanism of Air by Water>

The air cooling of the PRSFs pack 20 is based on an evaporation and convection heat exchanging mechanism between air and water. The water to be used is the ground water, whose temperature is around 11-22° C. over the southern part of the Northern America, see the temperature of ground water in Northern America described in “Formisano B., Tankless Water Heater.” The evaporation of such water needs some energy or heat, which is absorbed from the air contacted on the surface of water. In turn, the air is cooled as much as heat lost. For instance, supposing the temperatures of the water and air are 18 and 28° C., respectively, the heat preserved in the air is transferred into the water, while the surface of the water of lower temperature is contacted with the air of higher temperature. Then, some of water molecules near the surface of water absorb the transferred heat until their temperatures rise up to that of the air and then they are evaporated after they absorb the transferred heat as much as latent heat of water. More precisely, the temperatures of the water surface molecules may rise up to a lower temperature (let's say 25° C.) than that of the air, due to heat resistance of the water surface and short contacting time of air and water (a short passing time of water through the PRSFs pack). Hence, specific heat of water per one gram to need for rising from 18° C. to 25° C. is 7 Cal/g and its latent heat for vaporization is 540 Cal/g. Namely, for the evaporation of one gram of water of 18° C., 547 Cal/g is necessary. Eventually, the air loses as much amount of heat as that of the gained heat of the water and in turn the air is cooled. In order to transfer more heat, the longer contacting time of air and water is needed. However, the PRSF 15 should be designed within a limited length. Therefore, the optimizing length of the PRSF 15 should be determined from its experiment. While the water passes through the PRSFs pack 20, some of the heated water molecules on the water surface evaporate into the air, but most of the heated water molecules pass out of the PRSFs pack 20. Consequently, most of heat transferred to water gets out of the ARAC 9 without evaporating, resulting in cooling the air within the poultry houses and warming water.

<Absorption of Water Vapor>

While the indoor air is cooled by evaporation heat exchanging of water in case of cooling the house using evaporative technology, the water vapor is generated and dispersed into the house and accumulated. Operating the ARAC 9 without removal of water vapor, the accumulated water vapor may be deposited on the floor and cause to generate NH₃ gas. To prevent such unexpected cause of the water vapor, the WVRD 10 is equipped by attaching at the rear side of the AWC 2 in the ARAC 9. The function of the WVRD 10 is to contact the water vapor with the surface of cold water flowing down on the surface of the rods 19 to condense the water vapor into the cold water. While the air including the water vapor generated during passing through the AWC 2 is traveling through the WVRD 10, the air contacts with colder water. As a result of such an interaction, the temperature of the air is getting lower. Then, the water vapor in the air is condensed into water as much as amount of water vapor higher than saturated vapor density of water. For instance, assuming that the temperatures of the water vapor and cold water in the WVRD 10 are 30 and 20° C., respectively, and that they are saturated vapors at those temperatures, it can be understood that water vapor is reduced by 43% (0.43=(30.4−17.3)/30.4, saturated vapor densities of water at 30 and 20° C., are 30.4 and 17.3 g/m³, respectively).

<Conversion of Wet NH₃ to Fertilizer>

Most of the NH₃ dissolved in water remains as a unionized NH₃ (free NH₃) and the free NH₃ is ready to volatilize back into atmosphere again. A natural zeolite ion exchanger 33, clinoptilolite, has a high chemical affinity of aqueous NH₄⁺, read the property of the clinoptilolite described in “Denes Kallo.” To adsorb all of NH₃ in water on the clinoptilolite and to prevent the release of the NH₃ into the atmosphere, the circulating water maintains acid to convert free NH₃ into NH₄⁺. To make the water acidic, phosphoric acid is added to the water. Then, some of NH₄⁺ formed in water is reacted with phosphoric acid to produce an ammonium hydrogen phosphate ((NH₄)₂HPO₄), and also the ammonium hydrogen phosphate produced when the spent clinoptilolite is regenerated. This ammonium hydrogen phosphate can be used as fertilizer, see more information on production of fertilizer from regeneration of spent clinoptilolite in “Denes Kallo.” The NH₃ dissolved in water should be removed out of the system and then converted to a stable state or destructed to other stable components, because most of the NH₃ in water remains as free NH₃ and is ready to volatilize into the atmosphere. The technologies to be used for such purposes are usages of natural zeolite ion exchanger column, ozone oxidizer, and EC-2556 biotechnology, which are currently used in industries for the same purposes. The ion exchanger column 33 converts such free NH₃ to a stable state like ammonium hydrogen phosphate, the ozone oxidizer oxidizes the NH₃ to ammonium nitrate (NH₄NO₃), see “the Engineering ToolBox,” and EC-2556 bacteria destructs the NH₃ into nitrate or nitrite, see destruction of ammonia by bacteria in http://www.ecochem.com/t2556.html. The natural zeolite ion exchanger column 33 is more in detail described below, because it has a couple of advantages, compared with the other technologies. The ion exchanger column 33 uses natural zeolite clinoptilolite, which has several advantages such as a high chemical affinity for NH₄⁺, high adsorption capacity of ions, low cost, simplicity of application and operation, compared to the other ion exchanger and conventional methods like biological treatment, oxidizer, etc, read more information on ammonia destruction technologies in “Anonis A. Zorpas, et al.”

<Determination of Optimum Number of Rods in VFAR and ARAC>

The wider surface of water to be contacted with NH₃ gas is, the more amount of NH₃ gas is absorbed, so that the more number of rods 19 should be used in the AWC 2 of the VFAR 1 and ARAC 9 to provide much larger contacting surface between air and water. But too many rods may cause the pressure drop of air flow passing through the rods because the open area for air to pass is reduced and because the small open area resists the passing of the air. Then, the flowing rate of air passing the PRSFs pack 20 is reduced. Eventually, the air is not cooled enough and the removal of NH₃ is reduced by the reduction of the air flow rate. To avoid this problem, an optimum number of rods 19 should be used in the AWC 2 and WVRD 10. The optimum number of rods 19 means the maximum number of rods 19 per unit cross area not to reduce the air flowing rate as well as to maximize contacting surface of the rods 19, The optimum number of rods 19 used in the present invention is 7 rods per 25 cm² for rods 19 of 1.0 cm in diameter by employing the data used in other field related with optimum number of rods 19.

<Operation of ARAC (Simultaneous NH₃ Removal and Air Cooling System)>

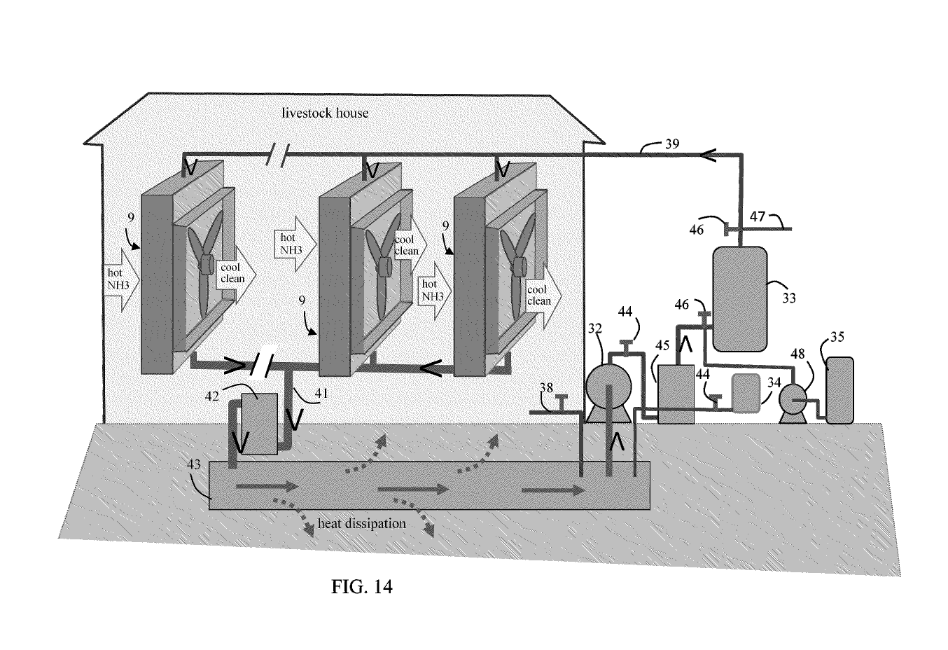

The operating schematic diagram of the Simultaneous NH₃ Removal and Air Cooling System (SAAS) is shown in FIG. 14. The SAAS consists of major components, ARAC 9, clinoptilolite ion exchanger column (CIEC) 33, water circulation pump (WCP) 32, and underground water cooling tank (UWCT) 43. The several ARACs 9 are suspended from the ceiling of the poultry house and connected to water inlet and outlet flexible hoses and other components are connected as shown in FIG. 14. When the SAAS is operated, the WCP 32 pumps out water from the UWCT 43 and circulates the water through a filter tank 42, 45, the CIEC 33, the ARACs 9, and returning to the UWCT 47. While the water is circulated through the SAAS, the axial motor fans 9 of the ARACs 7 blows the air out to pass through the ARACs 9 as shown in FIG. 14. The water flowing down on the surface of the rods 19 contacts with the air perpendicularly passing through the AWC 2 and then the water simultaneously absorbs the NH₃ and cools the air during flowing down of water on the surface of the rods. The air passed through the AWC 2 is a cool air with a little water vapor, which is removed in the WVRD 10 next to the AWC 2. The air passed the AWC 2 and WVRD 10 is cool and fresh air which is dispersed into the livestock house through the fan blower in the ARAC 9. The water passed the AWC 2 and WVRD 10 contaminates with NH₃ and dust and circulates through the primary filter tank 42 to the UWCT 43. While the water is passing the UWCT 43, the heat preserved in the water is dissipated to the ground to maintain its temperature same as the temperature of the ground. The water completely passed the UWCT 43 circulates to the secondary filter tank 45. The secondary filter tank 45 filters remains of dust not to be filtered in the primary filter tank 43 in order to protect the zeolites in the CIEC 33 from their ion exchange capability. The filtered water passed through the second filter tank 45 circulates to the CIEC 33 in which NH₃ absorbed in the water is adsorbed on the ion exchanger, clinoptilolite, after converted into ionized ammonia (ammonium ions, NH₄⁺). The water passed the CIEC 33 is clean water without any NH₄⁺ and circulates to the ARACs 9. After the clean water reaches the ARACs 9, the previous process of the water repeats to remove the NH₃ and cool the air.

<Operation of VFAR>

The schematic picture of the operating of the ammonia gas removal system (AGRS) using the VFAR 1 is shown in FIG. 13. The FIG. 13 illustrates the connection of the 5 VFARs 1 installed on the wall of the poultry house to the water supplying and wet NH₃ stabilizing system, which consists of the CIEC 33, WCP 32, regenerating solution tank 35, phosphoric acid tank 41, and fertilizer precipitation tank 36, 37. The AGRS is not operated independently and operated under operating of the livestock house maintenance system, since the ventilation fan is electrically connected to the livestock maintenance system. Therefore, the AGRS is operated while the livestock house maintenance system is operated. During the operation of the livestock house maintenance system, the air is passing through the VFARs 1 of the AGRS. Then, the WCP 32 is operated to circulate water from the water tank 30 through the filter tank 45, CIEC 32, VFARs 1 and return to the water tank 30. While the water is circulated through the VFARs 1, the water is flowing down on the surface of the rods 19 and contacted with the air transversely passing through the AWC 2 and then the water absorbs the NH₃ gas from the air. The water passed the VFARs 1 is contaminated with NH₃ and the NH₃ is converted to NH₄⁺ by reaction of NH₃ with H₃PO₄ dissolved in the water. NH₄⁺ is stripped from the circulated water passing through the CIEC 33. The water passed the CIEC 33 contains nearly none of NH₄⁺ and circulated into the VFAR 1 to pick up the NH₃ from the air. When the NH₄⁺ absorption capability of the CIEC 33 is reduced to ½, the CIEC 33 is regenerated with KCL in phosphoric acid solution to produce the ammonium hydrogen phosphate ((NH₄)₂HPO₄) fertilizer.

What is claimed is:

1. A ventilation-fan-ammonia-gas-removal-device, comprising:
an axial motor ventilation fan located on the front side of said ventilation-fan-ammonia-gas-removal-device;
a water and air contactor consisting of several plastic-rod-screen-fills packs, placed on the rear side of said axial motor ventilation fan.

2. A ammonia-gas-removal-and-air-cooling-equipment, comprising;
an axial motor fan blower placed on the front side of said dual-function-ammonia-gas-removal-and-air-cooling-equipment;
a water and air contactor located on the rear side of said dual-function-ammonia-gas-removal-and-air-cooling-equipment, having several plastic-rod-screen-fills packs.
a water-vapor-removal-device located between said axial motor fan blower and said water and air contactor, having several plastic-rod-screen-fills packs.

3. A water and air contactor as in claims 1 and 2, wherein said plastic-rod-screen-fills pack having a multiplicity of plastic-rod-screen-fills each consisting of top and bottom frames and plate type plastic-rod-screen-fill between them in one structure, each of said plastic-rod-screen-fill having vertical rods separated sufficiently apart from each other, wherein said vertical plastic rods suspending from top and bottom frame of said plastic-rod-screen-fill and wherein said plastic rods attached at the center of the semi-circular holes on the top and bottom frame of said plastic-rod-screen-fill, wherein said plastic-rod-screen-fill having several attachment tabs on top and bottom frames of said plastic-rod-screen-fill, each of said male and female attachment tabs locating on side and top surfaces of top and bottom frames of said plastic-rod-screen-fill for adjoining together of said plastic-rod-screen-fills, whereby said male and female attachment tabs are joined by aligning said attachment tabs with and inserting into the counterpart attachment tabs and pressing them.

4. A water-vapor-removal-device as in claim 2, wherein said plastic-rod-screen-fills pack having a multiplicity of plastic-rod-screen-fills each consisting of top and bottom frames and plate type plastic-rod-screen-fill between them in one structure, each of said plastic-rod-screen-fill having vertical rods separated sufficiently apart from each other, wherein said vertical plastic rods suspending from top and bottom frame of said plastic-rod-screen-fill and wherein said plastic rods attached at the center of the semi-circular holes on the top and bottom frame of said plastic-rod-screen-fill, wherein said plastic-rod-screen-fill having several attachment tabs on top and bottom frames of said plastic-rod-screen-fill, each of said male and female attachment tabs locating on side and top surfaces of top and bottom frames of said plastic-rod-screen-fill for adjoining together of said plastic-rod-screen-fills, whereby said male and female attachment tabs are joined by aligning said attachment tabs with and inserting into the counterpart attachment tabs and pressing them.
